(19) United States
(12) Patent Application Publication
(10) Pub. No.: US 2024/0129149 A1
(43) Pub. Date: Apr. 18, 2024

(54) QUALITY STATUS LOOPBACK FOR ONLINE COLLABORATION SESSIONS

(71) Applicant: Intel Corporation, Santa Clara, CA (US)

(72) Inventors: Aiswarya M. Pious, Bangalore (IN); Tao Tao, Portland, OR (US); Stanley Jacob Baran, Chandler, AZ (US); Michael Daniel Rosenzweig, Queen Creek, AZ (US); Chia-Hung Sophia Kuo, Folsom, CA (US); Rahul R, Aluva (IN); Nagalakshmi S, Bengaluru (IN); Praveen Kashyap Ananta Bhat, Bangalore (IN); Balvinder Pal Singh, Bhilai (IN); Navya P, Bangalore (IN); Jason Tanner, Folsom, CA (US); Passant V. Karunaratne, Chandler, AZ (US); Venkateshan Udhayan, Portland, OR (US); Srikanth Potluri, Folsom, CA (US)

(21) Appl. No.: 18/397,668

(22) Filed: Dec. 27, 2023

(51) Int. Cl. H04L 12/18; G06F 3/04817; H04L 51/04; H04L 65/1069; H04L 65/80

(52) U.S. Cl. CPC H04L 12/1831; G06F 3/04817; H04L 51/04; H04L 65/1069; H04L 65/80

(57) ABSTRACT

An example apparatus disclosed herein is to receive network data communicated via a first channel associated with the online collaboration session, the network data including received media data packets. The disclosed example apparatus is also to analyze the network data to determine first loopback data, the first loopback data including at least one of a first quality score based on a first analysis of the received media data packets or a second quality score based on a second analysis of media decoded from the received media data packets. The disclosed example apparatus is also to analyze local data obtained by a local client during the online collaboration session to determine second loopback data. The disclosed example apparatus is further to cause transmission of a loopback message to a moderator client via the second channel, the loopback message based on the first loopback data and the second loopback data.

### FIELD OF THE DISCLOSURE

This disclosure relates generally to online computing and, more particularly, to quality status loopback for online collaboration sessions.

### BACKGROUND

Online collaboration systems, such as video conferencing systems, virtual classroom systems, etc., enable participants to communicate media data, such as audio data and/or video data (collectively referred to as audiovisual data), text/chat data, etc., in a shared manner. A challenge associated with such online collaboration systems is to maintain a consistent audiovisual experience for the participants throughout an online collaboration session.

### BRIEF DESCRIPTION OF THE DRAWINGS

FIG. 1 is a block diagram of example session monitor clients that implement quality status loopback for an online collaboration session in accordance with teachings of this disclosure and shown in an example environment.

FIG. 2 is a block diagram of an example implementation of any of the session monitor clients of FIG. 1.

FIG. 3 illustrates another example environment in which two of the session monitor clients of FIG. 1 operate to determine example quality scores for an online collaboration session.

FIGS. 4-6 illustrate example quality scores and quality indicators determined by the session monitor clients of FIGS. 1-3.

FIGS. 7-9 are flowcharts representative of example machine readable instructions and/or example operations that may be executed, instantiated, and/or performed by example programmable circuitry to implement the session monitor client 105 of FIG. 2.

FIG. 10 is a block diagram of an example processing platform including programmable circuitry structured to execute, instantiate, and/or perform the example machine readable instructions and/or perform the example operations of FIGS. 7-9 to implement the session monitor client 105 of FIG. 2.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In online collaboration systems, such as video conferencing systems, virtual classroom systems, etc., participants utilize client devices, such as personal computers, laptop computers, tablet computers, smartphones, etc., to establish an online collaboration session to communicate media data, such as audio data and/or video data (collectively referred to as audiovisual data), text/chat data, etc., in a shared manner. As noted above, a challenge associated with such online collaboration systems is to maintain a consistent audiovisual experience for the participants throughout an online collaboration session. For example, during an online video conferencing session, productivity can be negatively impacted when a participant on the receiving end cannot see and/or hear the participant on the sending side. Furthermore, detecting and isolating such issues in an existing video conferencing system may be a time consuming process as it relies on participants reporting any issues verbally and potentially reaching a consensus as to the cause(s) of the issues.

In contrast, online collaboration systems as disclosed herein utilize example session monitor clients to automatically detect and report problems to session participants. Examine session monitor clients disclosed herein implement a loopback mechanism to monitor media quality locally at the individual client devices of the online collaboration system and report status to a session moderator, which may be a participant who organized the online collaboration session, or is a current presenter in the sessions, etc. For example, the session monitor clients can operate as local clients to monitor the quality of the audio and/or video data received and/or transmitted by the respective client devices and report corresponding quality scores to the session monitor client associated with the session moderator. The session monitor client associated with the session moderator can operate as a moderator client to collate the reported quality scores, which represent the quality of the received and/or transmitted audio and/or video data at the respective client devices, as well as local quality scores determined by the moderator client itself, to determine quality indicators for a current time interval of the online session. In some examples, the quality indicators can be used by the moderator client to display problems occurring during the current interval of the online session and/or notify a particular participant associated with a detected problem.

In some examples, the session monitor clients operate to monitor the network data (e.g., network packets) conveying media data (e.g., audio and/or video data) among the client devices included in the online collaboration session. In some examples, the session monitor clients additionally/or alternatively monitor the received media data decoded from the network data received by a given client device and the transmitted media data to be encoded in network data to be transmitted by the given client device. In some examples, the session monitor clients additionally/or alternatively implement driver interface(s) to interface with drivers on the client devices to monitor connections with input/output devices (e.g., media endpoints) providing and/or presenting the media associated with the online collaboration session, such as a local speaker of the client device, a display of the client device, a peripheral such as a Bluetooth® headset, etc., a universal serial bus (USB) interface, etc.

In some examples, the session monitor clients implement quality confirmation techniques to reduce the probability of false detections of quality issues during a current interval of an online collaboration session. For example, a given session monitor client may implement keyword matching techniques, as disclosed in further detail below, to confirm the accuracy of computed quality score(s) to be reported by that session monitor client. Additionally or alternatively, in some examples, the session monitor clients may buffer media data for some period of time. In response to detection of an issue associated with a particular participant, one of the session clients that buffered the media data (e.g., the moderator client) can provide the missing media data to the particular participant after the issue is resolved.

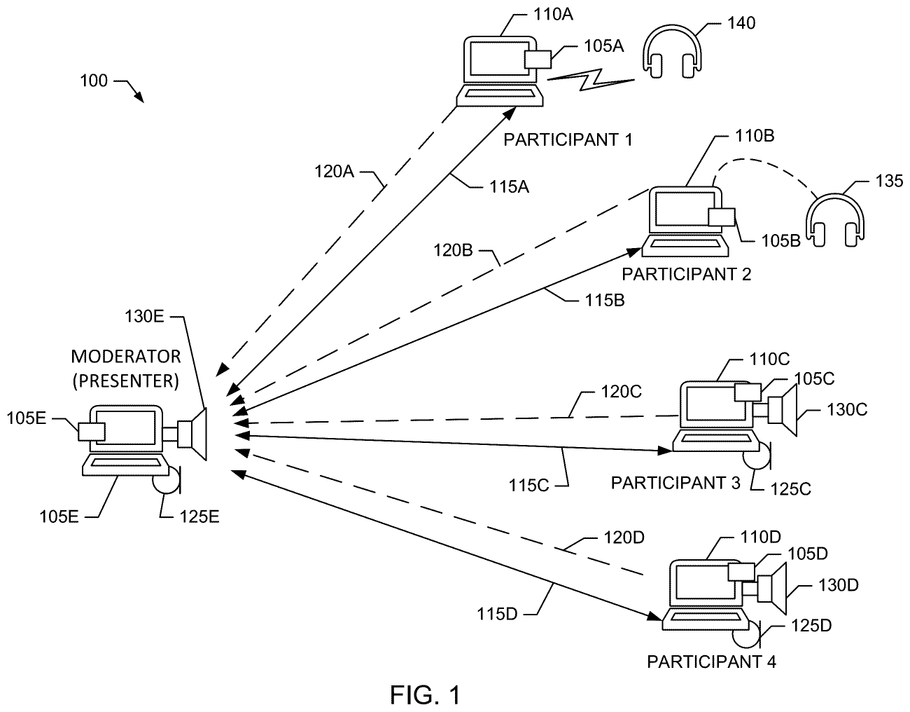

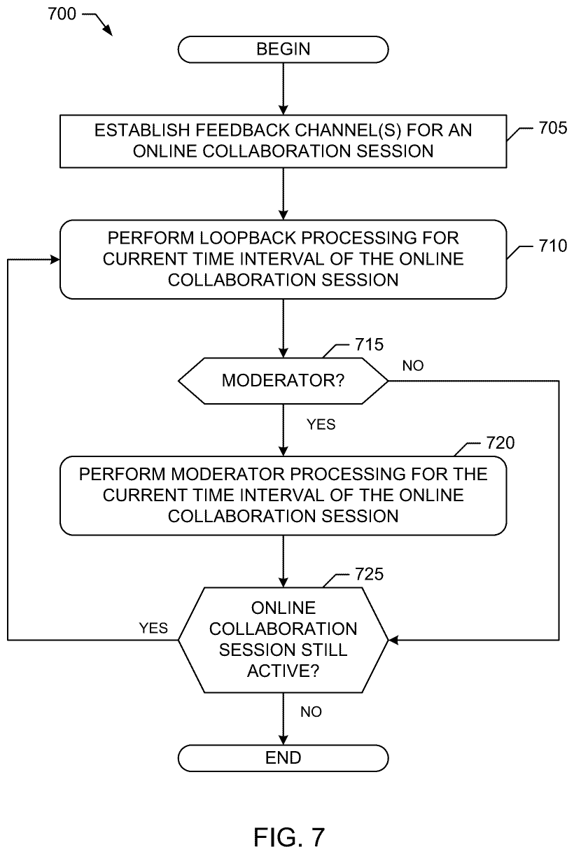

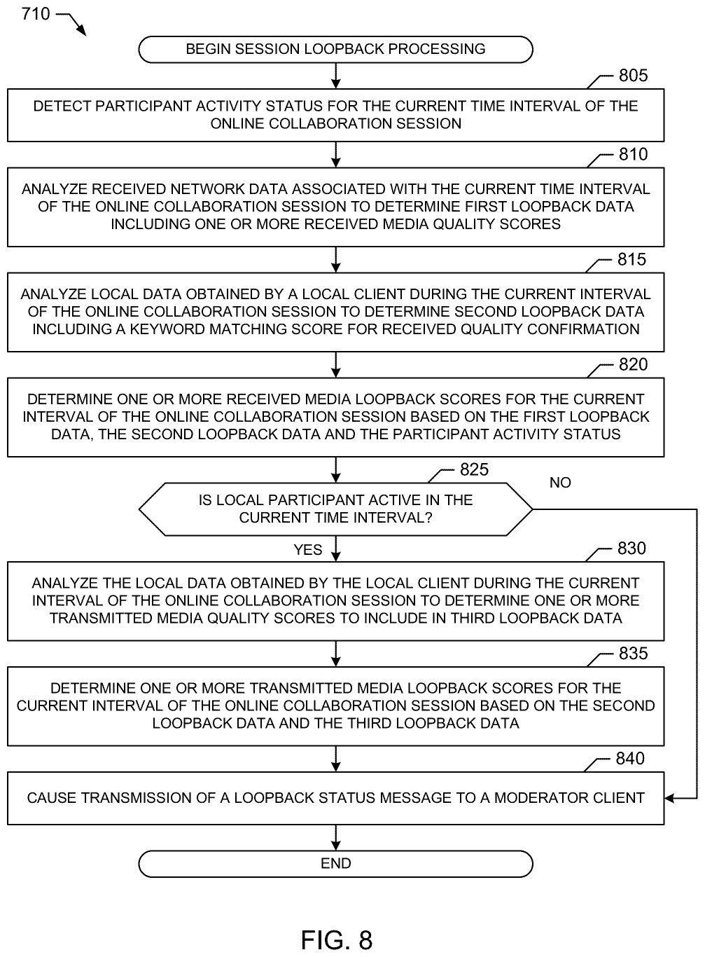

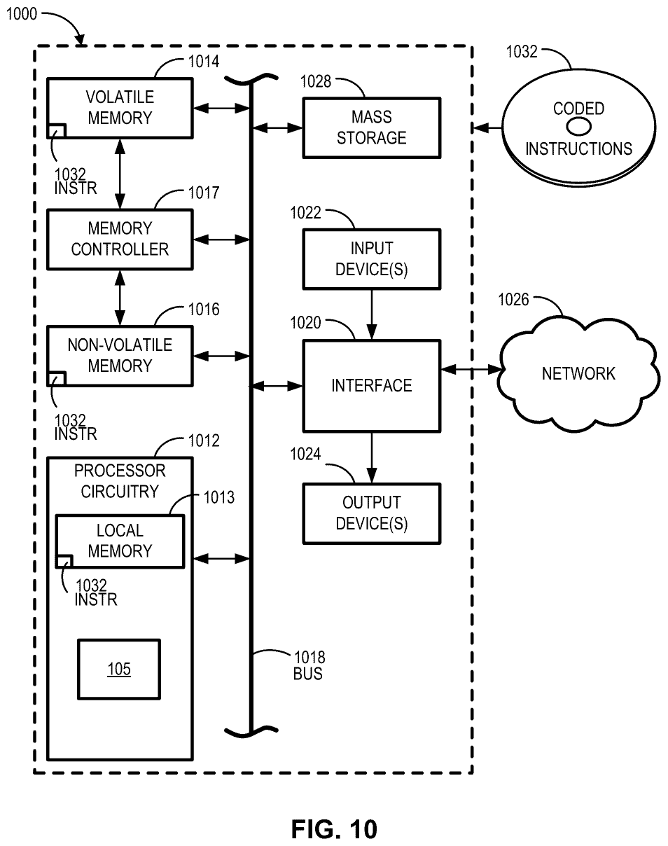

Turning to the figures, FIG. 1 is a block diagram of example session monitor clients 105A-E that implement quality status loopback for an online collaboration session in accordance with teachings of this disclosure and shown in an example environment 100. In the illustrated example of FIG. 1, the session monitor clients 105A-E are executed or otherwise implemented by respective example client devices 110A-E included in the online collaboration session. The client devices 110A-E can be implemented by any type(s) and/or number(s) of client devices, such as one or more personal computers, laptop computers, tablet computers, smartphones, etc. In some examples, one or more of the client devices 110A-E are implemented by a processing platform such as the example processor platform 1000 of FIG. 10 executing instructions such as the instructions represented by the flowcharts of FIGS. 7, 8 and/or 9.

In the illustrated example of FIG. 1, the client devices 110A-E execute or otherwise implement respective online collaboration applications to implement the online collaboration session. For example, the online collaboration applications can be any online collaboration application, such as, but not limited to, Microsoft® Teams™, Zoom™, etc. The client devices 110A-E use the online collaboration applications to establish example main communication channels 115A-D to communicate collaboration data, such as audio data, video data, presentation data, text/chat data, etc., among the client devices 110A-E in the online collaboration session. For example, the audio data can be voice data captured with microphones at the respective client devices, the video data can be streaming video data captured with cameras at the respective client devices, the presentation data can be screen/window sharing data provide by a client device that is sharing an screen or application window, the text data can chat data entered at the respective client devices, etc.

As noted above, the client devices 110A-E also use the session monitor clients 105A-E to implement quality status loopback for an online collaboration session. In some examples, the session monitor clients 105A-E are included in the online collaboration applications executed/implemented by the client devices 110A-E. In some examples, the session monitor clients 105A-E are separate clients that are executed/implemented by the client devices 110A-E to interface with the online collaboration applications executed/implemented by the client devices 110A-E.

In the illustrated example of FIG. 1, the session monitor clients 105A-E establish respective example feedback channels 120A-D to communicate example loopback status messages for monitoring the online collaboration session. As disclosed above and in further detail below, the session monitor clients 105A-E monitor the quality of the media data (e.g., audio data, video data, presentation data, text/chat data, etc.) received and to be transmitted by the respective client devices 110A-E via the main communication paths 115A-D during successive time intervals of the online collaboration session. In the illustrated example of FIG. 1, the session monitor clients 105A-D determine and report corresponding quality scores via the feedback channels 120A-D to the session monitor client 105E that is acting as an example session moderator client 105E during a given time interval of the online collaboration session.

In the illustrated example, the session moderator client 105E is associated with the collaboration session participant who is deemed the moderator of the session for the given time interval. For example, the session moderator can be the organizer of the online collaboration session and remain unchanged throughout the duration of the session. In such an example, the session moderator client 105E may also remain unchanged throughout the duration of the session. In some examples, the session moderator is the participant who is actively presenting (e.g., screen sharing) during the given time interval of the online collaboration session. In such examples, the session moderator client 105E may switch among the different session monitor clients 105A-E depending on which participant is actively presenting (e.g., screen sharing) during a given time interval. In some examples, there may be multiple session moderator clients, such as one session moderator client associated with the session organizer and another session moderator client associated with the active presenter, and the session monitor clients 105A-D may report their quality scores to the multiple session moderator clients via the feedback channels 120A-D.

As described above and in further detail below, the session monitor clients 105A-E of the illustrated example monitor the quality of the media data (e.g., audio data, video data, presentation data, text/chat data, etc.) and associated network data (e.g., network packets) received and to be transmitted by the respective client devices 110A-E via the main communication paths 115A-D. In some examples, the session monitor clients 105A-E also monitor the quality of the media data (e.g., audio data, video data, presentation data, text/chat data, etc.) generated and/or presented locally at the respective client devices 110A-E for inclusion in the online session. For example, the session monitor clients 105A-E can implement driver interface(s) to monitor connections with the input/output devices (e.g., media endpoints) of the client devices 110A-E and analyze the quality of the media generated and/or presenting by the client devices 110A-E locally in association with the online collaboration session. For example, the session monitor clients 105C-E utilize local microphone and speaker driver interfaces to monitor the audio data generated by example local microphones 125C-E and presented by example local speakers 130C-E of the respective client devices 110C-E. In the illustrated example, the session monitor client 105B utilizes a USB driver interface to monitor the audio data generated and presented by an example USB headset 135. In the illustrated example, the session monitor client 105A utilizes a Bluetooth® driver interface to monitor the audio data generated and presented by an example Bluetooth® headset 140.

As described above and in further detail below, the session moderator client 105E of the illustrated example determines one or more quality indicators for a given time interval of the online session based on the loopback status messages received via the feedback channels 120A-D for that time interval. In some examples, session moderator client 105E also uses its own local quality scores in the determination of the one or more quality indicators. As described above and in further detail below, session moderator client 105E utilizes the quality indicator(s) to display problems occurring during the given interval of the online session and/or notify a particular participant associated with a detected problem.

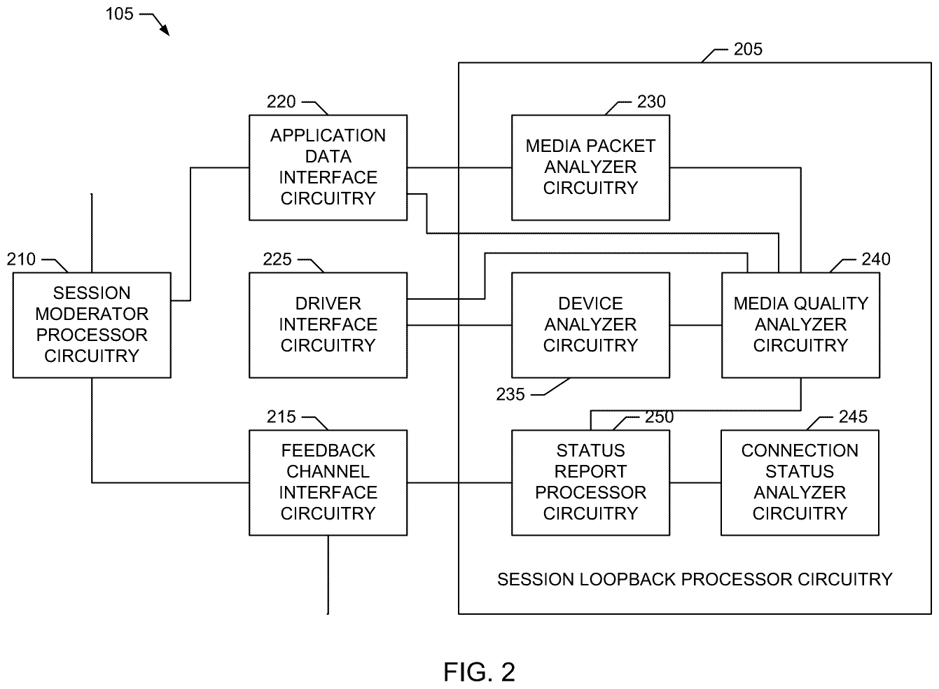

FIG. 2 is a block diagram of an example implementation of an example session monitor client 105 that can be used to implement any of the session monitor clients 105A-E of FIG. 1. The session monitor client 105 of FIG. 2 may be instantiated (e.g., creating an instance of, bring into being for any length of time, materialize, implement, etc.) by programmable circuitry such as a Central Processor Unit (CPU) executing first instructions such as the instructions represented by the flowcharts of FIGS. 7, 8 and/or 9. Additionally or alternatively, the session monitor client 105 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example session monitor client 105 of FIG. 2 includes example session loopback processor circuitry 205, also referred to herein as the session loopback processor 205 for convenience, to perform session loopback processing for an online collaboration session. The example session monitor client 105 of FIG. 2 also includes example session moderator processor circuitry 210, also referred to herein as the session moderator processor 210 for convenience, to perform session moderator processing for the online collaboration session. The example session monitor client 105 of FIG. 2 also includes example feedback channel interface circuitry 215, also referred to herein as the feedback channel interface 215 for convenience, to implement a feedback channel to transmit and/or receive loop back status messages (e.g., such as loopback protocol data units (PDUs), loopback packets, etc.) associated with monitoring the online collaboration session. For example, the feedback channel interface 215 can utilize defined packet headers, information elements, etc., to encode loopback status messages for communication via a feedback channel and to decode loopback status messages obtained via feedback channel. In some examples, the feedback channel interface 215 can utilize one or more particular channel(s) of a wired and/or wireless communication system as the feedback channel.

The example session monitor client 105 of FIG. 2 includes example application data interface circuitry 220 and example driver interface circuitry 225 to access media data associated with an online collaboration session. For convenience, the application data interface circuitry 220 may also be referred to herein as the application data interface 220, and the driver interface circuitry 225 may be referred to herein as one or more driver interface(s) 225. In the illustrated example, the application data interface 220 operates to access media data associated with an online collaboration application implementing the online collaboration session. For example, the application data interface 220 accesses received network data, such as received network packets, conveying media data (e.g., audio data, video data, presentation data, text/chat data, etc.) received, at the client device executing the session monitor client 105, from one or more remote participants of the online collaboration session. In some examples, the application data interface 220 additionally or alternatively accesses the received media data (e.g., audio data, video data, presentation data, text/chat data, etc.) decoded by the online collaboration application from the received media packets, and/or accesses media data (e.g., audio data, video data, presentation data, text/chat data, etc.) generated at the client device and to be encoded for transmission by the online collaboration application. In some examples, the application data interface 220 utilizes one or more application programming interfaces (APIs) to interface with the online collaboration application to access the received media data, the transmitted media data, the network data, etc. associated with the online collaboration session. In some examples, the application data interface 220 utilizes one or more APIs to interface with a network interface controller (NIC) and/or other circuitry to access the network packets associated with the online collaboration session.

In the illustrated example, the driver interface(s) 225 access one or more drivers of a client device, which is executing the session monitor client 105, to monitor connections with input/output devices (e.g., media endpoints) providing and/or presenting the media associated with the online collaboration session. The driver interface(s) 225 of the illustrated example also access media data (e.g., audio data, video data, presentation data, text/chat data, etc.) generated by and/or to be presented by the input/output devices (e.g., media endpoints) for the online collaboration session. For example, the driver interface(s) 225 may include one or more of a local microphone interface to access audio data generated by a local microphone of the client device, a local speaker interface to access audio data to be output by a local speaker of the client device, a local display interface to access video data to be output to a display of the client device, a USB driver interface to access audio data and/or video data generated by and/or to be presented by one or more USB peripherals (e.g., USB headset, USB monitor, etc.) of the client device, Bluetooth® driver interface to access audio data and/or video data generated by and/or to be presented by one or more Bluetooth® peripherals (e.g., Bluetooth® headset, Bluetooth® monitor, etc.) of the client device, etc.

The example session loopback processor 205 in the example session monitor client 105 of FIG. 2 includes example media packet analyzer circuitry 230, example device analyzer circuitry 235, example media quality analyzer circuitry 240, example connection status analyzer circuitry 245, and example status report processor circuitry 250. For convenience, the media packet analyzer circuitry 230 may be referred to herein as the media packet analyzer 230, the device analyzer circuitry 235 may be referred to herein as the device analyzer 235, the media quality analyzer circuitry 240 may be referred to herein as the media quality analyzer 240, the connection status analyzer circuitry 245 may be referred to herein as the connection status analyzer 245, and the status report processor circuitry 250 may be referred to herein as the status report processor 250. In the illustrated example, the media packet analyzer 230 operates to determine loopback data based on received network data (e.g., network packets) conveying received media associated with a current time interval of an online collaboration session. The segmenting of the online collaboration session into time intervals is described in further detail below in the discussion of the media quality analyzer 240. In some examples, the loopback data determined by the media packet analyzer 230 includes a first set of one or more received media quality scores determined by analyzing the network packets conveying the received media data, which are received from one or more remote participants of the online collaboration session. For example, the first set of one or more received media quality scores can include a video packet quality score determined by analyzing the network packets conveying the received video data for the current time interval of the online collaboration session, an audio packet quality score determined by analyzing the network packets conveying the received audio data for the current time interval of the online collaboration session, a presentation packet quality score determined by analyzing the network packets conveying the received presentation data (e.g., screen sharing data) for the current time interval of the online collaboration session, a text packet quality score determined by analyzing the network packets conveying the received text/chat data for the current time interval of the online collaboration session, etc.

In the illustrated example, the media packet analyzer 230 utilizes the application data interface 220 to access (e.g., from the online collaboration application, the NIC, etc.) the received network data (e.g., network packets) conveying received media associated with the current time interval of the online collaboration session. The media packet analyzer 230 can perform any type(s) and/or number(s) of analyses on the received network packets to determine the first set of quality score(s). For example, the media packet analyzer 230 can analyze round trip time, packet loss rate, packet error rate, number of retransmissions, number of corrections, etc., for the respective received video packets, the received audio packets, the received presentation data packets, the received text data packets, etc., to determine the respective video packet quality score, audio packet quality score, presentation packet quality score, text packet quality score, etc., included in the first set of received media quality score(s) for the current time interval of the online collaboration session. In some examples, the media packet analyzer 230 computes the first set of received media quality score(s) initially as quantitative values in some range (e.g., 0 to 1, 0 to 100%, etc.) and converts/bins the numeric values into qualitative score values, such as “good,” “average,” “poor,” etc.

In some examples, the loopback data determined by the media packet analyzer 230 includes a second set of one or more received media quality scores determined by analyzing the media data decoded from the received network packets for the current time interval of the online collaboration session. For example, the second set of one or more received media quality scores can include a received video quality score determined by analyzing the decoded video data received for the current time interval of the online collaboration session, a received audio quality score determined by analyzing the decoded audio data received for the current time interval of the online collaboration session, a received presentation data quality score determined by analyzing decoded presentation data (e.g., screen sharing data) for the current time interval of the online collaboration session, a received text data quality score determined by analyzing the decoded text/chat data for the current time interval of the online collaboration session, etc.

In the illustrated example, the media packet analyzer 230 utilizes the application data interface 220 to access the received media data decoded (e.g., by the online collaboration application) from the received network packets associated with the current time interval of the online collaboration session. The media packet analyzer 230 can perform any type(s) and/or number(s) of analyses on the received media data to determine the second set of received media quality score(s). For example, the media packet analyzer 230 can analyze signal-to-noise ratio (SNR), frame rate, error rate, distortion, etc., for the decoded video data, decoded audio data, decoded presentation data, decoded text data, etc., to determine the respective received video quality score, received audio quality score, received presentation data quality score, received text data quality score, etc., included in the second set of quality received media score(s) for the current time interval of the online collaboration session. In some examples, the media packet analyzer 230 computes the second set of received media quality score(s) initially as quantitative values in some range (e.g., 0 to 1, 0 to 100%, etc.) and converts/bins the numeric values into qualitative score values, such as “good,” “average,” “poor,” etc.

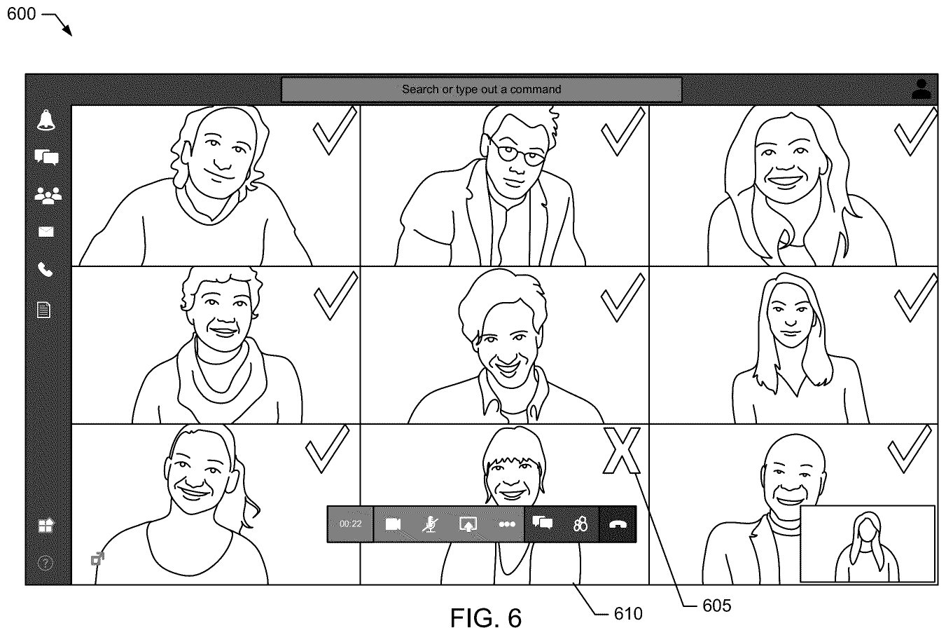

In some examples, the online collaboration application is able to associate the received network data (e.g., the network packets) with particular client devices and/or participants included in the online collaboration session. For example, one or more participants may stream video data captured with cameras at their respective client devices. In some such examples, the network packets accessed by the online collaboration application may identify the video streams from the different participants' client devices, and the online collaboration application may decode the different video streams and cause the decoded video streams to be presented in different windows identified by their respective participants (see e.g., the example of FIG. 6). In some such examples, the media packet analyzer 230 uses the participant and/or client device identification information included in the network packets to compute one or more of the first set of quality score(s) and/or the second set of quality score(s) described above, but at the participant and/or client device level. For example, if participant and/or client device identification information is included in the network packets, the media packet analyzer 230 may determine respective video packet quality scores, audio packet quality scores, presentation packet quality scores, text packet quality scores, received video quality scores, received audio quality scores, received presentation data quality scores, received text data quality scores, etc., for different ones of the participants/client devices included in the online collaboration session.

In the illustrated example, the device analyzer 235 operates to determine loopback data based on local data generated at the client device for transmission during a current time interval of an online collaboration session. The segmenting of the online collaboration session into time intervals is described in further detail below in the discussion of the media quality analyzer 240. In some examples, the local data includes media data (e.g., video data, audio data, presentation data, text/chat data, etc.) generated at the client device (e.g., with a microphone, camera, headset, keyboard, application, etc.) and the loopback data determined by the device analyzer 235 includes a set of one or more transmitted media quality scores determined by analyzing the media data to be transmitted during the current interval of the online collaboration session (which is also referred to as transmitted media data herein because the media data is intended for transmission). For example, the set of one or more transmitted media quality scores can include a transmitted video quality score determined by analyzing the local video data generated for the current time interval of the online collaboration session, a transmitted audio quality score determined by analyzing the local audio data generated for the current time interval of the online collaboration session, a transmitted presentation data quality score determined by analyzing local presentation data (e.g., screen sharing data) generated for the current time interval of the online collaboration session, a transmitted text data quality score determined by analyzing the local text/chat data generated for the current time interval of the online collaboration session, etc.

In the illustrated example, the device analyzer 235 utilizes the driver interface 225 to access the transmitted media data generated locally by the client device for the current time interval of the online collaboration session. The device analyzer 235 can perform any type(s) and/or number(s) of analyses on the transmitted media data to determine the set of transmitted media quality score(s). For example, the device analyzer 235 can analyze signal-to-noise ratio (SNR), frame rate, error rate, distortion, etc., for the local video data, local audio data, local presentation data, local text data, etc., generated for transmission during the current time interval to determine the respective transmitted video quality score, transmitted audio quality score, transmitted presentation data quality score, transmitted text data quality score, etc., included in the set of transmitted media quality score(s) for the current time interval of the online collaboration session. In some examples, the device analyzer 235 computes the set of transmitted media quality score(s) initially as quantitative values in some range (e.g., 0 to 1, 0 to 100%, etc.) and converts/bins the numeric values into qualitative score values, such as “good,” “average,” “poor,” etc.

The example media quality analyzer 240 of FIG. 2 utilizes the received media quality score(s) determined by the media packet analyzer 230 and the transmitted media quality score(s) determined by the device analyzer 235 to determine loopback scores to include in loopback status messages reported by the status report processor 250. To facilitate generation of the loopback scores, the media quality analyzer 240 segments an online collaboration session into time intervals such that the quality score(s) determined by the media packet analyzer 230 and the device analyzer 235, and the loopback scores determined by the media quality analyzer 240, can be associated with the different time intervals of the online collaboration session. For example, the media quality analyzer 240 can implement or access one or more counters, timers, clock circuits, etc., that are synchronized with the start of the online collaboration session to segment the session into successive time intervals that can be used to trigger processing of the media packet analyzer 230, the device analyzer 235 and the media quality analyzer 240. In this manner, the media packet analyzer 230 and the device analyzer 235 can monitor the quality of their respective media data/packets continuously, and provide/report their respective quality scores periodically (e.g., at successive time intervals) to the media quality analyzer 240 for further processing.

In the illustrated example, the media quality analyzer 240 determines received media loopback scores for different time intervals of the online collaboration session based on the first set of received media quality score(s) and/or second set of received media quality score(s) determined by the media packet analyzer 230, as described above. For example, the media quality analyzer 240 can determine a received video quality score for a given (e.g., current) time interval based on the video packet quality score and/or the received video quality score determined by the media packet analyzer 230 for the given (e.g., current) time interval, as described above. Additionally or alternatively, the media quality analyzer 240 can determine a received audio quality score for a given (e.g., current) time interval based on the audio packet quality score and/or the received audio quality score determined by the media packet analyzer 230 for the given (e.g., current) time interval, as described above. Additionally or alternatively, the media quality analyzer 240 can determine a received presentation data quality score for a given (e.g., current) time interval based on the presentation packet quality score and/or the received presentation data quality score determined by the media packet analyzer 230 for the given (e.g., current) time interval, as described above. Additionally or alternatively, the media quality analyzer 240 can determine a received text data quality score for a given (e.g., current) time interval based on the text packet quality score and/or the received text data quality score determined by the media packet analyzer 230 for the given (e.g., current) time interval, as described above. In some examples, the media quality analyzer 240 can determine respective, received media loopback scores for different participants and/or client devices included in the online presentation if participant and/or client device identification information is included in the received network data. In some examples, the media quality analyzer 240 includes the participant and/or client device identification information with the respective media loopback scores to identify which scores are associated with which participants and/or client devices.

In the illustrated example, the media quality analyzer 240 also determines transmitted media loopback scores for different time intervals of the online collaboration session based on the set of transmitted media quality score(s) determined by the device analyzer 235, as described above. For example, the media quality analyzer 240 can determine a transmitted video quality score for a given (e.g., current) time interval based on the transmitted video quality score determined by the device analyzer 235 for the given (e.g., current) time interval, as described above. Additionally or alternatively, the media quality analyzer 240 can determine a transmitted audio quality score for a given (e.g., current) time interval based on the transmitted audio quality score determined by the device analyzer 235 for the given (e.g., current) time interval, as described above. Additionally or alternatively, the media quality analyzer 240 can determine a transmitted presentation data quality score for a given (e.g., current) time interval based on the transmitted presentation data quality score determined by the device analyzer 235 for the given (e.g., current) time interval, as described above. Additionally or alternatively, the media quality analyzer 240 can determine a transmitted text data quality score for a given (e.g., current) time interval based on the transmitted text data quality score determined by the device analyzer 235 for the given (e.g., current) time interval, as described above.

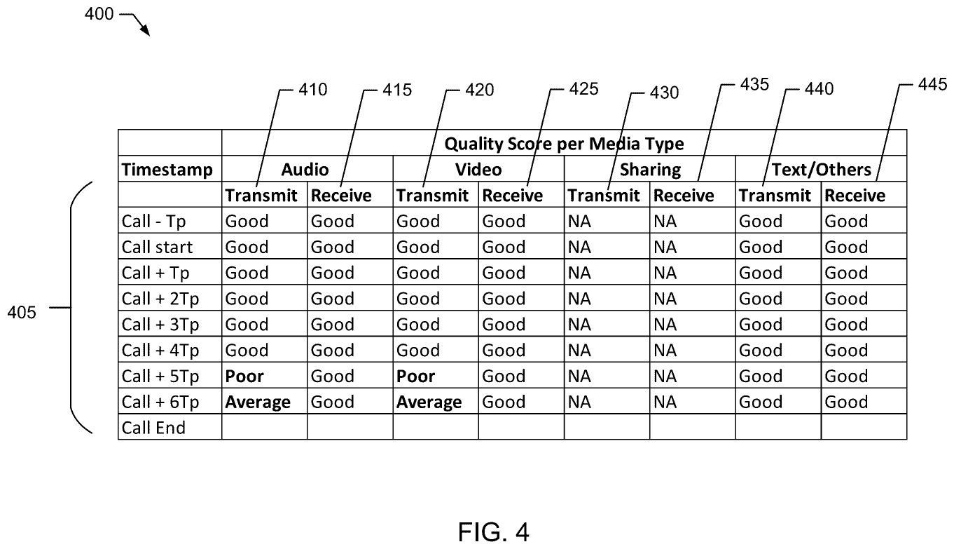

In some examples, the media quality analyzer 240 stores the received media loopback scores and the transmitted media loopback scores for different time intervals of the online collaboration session in one or more data structures, such as one or more tables, linked lists, databases, etc. An example table implemented by the media quality analyzer 240 to store the received media loopback scores and the transmitted media loopback scores for different time intervals of the online collaboration session is illustrated in FIG. 4, which is described in detail below.

In some examples, the media quality analyzer 240 conditions the received media loopback score(s) and/or the transmitted media loopback score(s) for a given (e.g., current) time interval on participant activity detected for that time interval. In the illustrated example, the media quality analyzer 240 utilizes the application data interface 220 to obtain participant activity status for a given (e.g., current) time interval from the online collaboration application implementing the online collaboration session. For example, the online collaboration application routinely detects and identifies the active session participant(s) who are transmitting media (e.g., audio, video, presentation data, text/chat data, etc.) during a given (e.g., current) time interval of the online collaboration session. The media quality analyzer 240 can access that participant activity status via the application data interface 220 to determine the active session participant(s), if any, during a given (e.g., current) time interval of the online collaboration session.

In some examples, the media quality analyzer 240 uses the participant activity status to override the received media loopback scores and/or the transmitted media loopback scores for a given (e.g., current) time interval by setting them to one or more default scores based on the participant activity status. For example, if the participant activity status indicates there are no active participants during a given (e.g., current) time interval (or the only active participant is the local participant associated with the client device executing the session monitor client 105), the media quality analyzer 240 may override any received media loopback scores by setting them to a default score (e.g., because there is no active participant that could be generating the received media in that time interval). Example of default scores could be quantitative values that do not represent a valid quality score (e.g., a value outside the permissible range of values, such as −1 of the range of permissible values is 0 to 1, 0 to 100%, etc.), or qualitative values that indicate the received media loopback score should be ignored for that time interval (e.g., such as “Ignore,” “Not Available,” “N/A,” etc.). Conversely, if the participant activity status indicates there is at least one active participant during a given (e.g., current) time interval (e.g., other than the local participant associated with the client device executing the session monitor client 105), the media quality analyzer 240 retains the received media loopback scores for inclusion in a loopback status message.

As another example, if the participant activity status indicates the local participant associated with the client device executing the session monitor client 105 is not active, the media quality analyzer 240 may override any transmitted media loopback scores by setting them to a default score (e.g., because local participant is not generating media to be transmitted in that time interval). Example of default scores could be quantitative values that do not represent a valid quality score (e.g., a value outside the permissible range of values, such as −1 of the range of permissible values is 0 to 1, 0 to 100%, etc.), or qualitative values that indicate the transmitted media loopback score should be ignored for that time interval (e.g., such as “Ignore,” “Not Available,” “N/A,” etc.). Conversely, if the participant activity status indicates the local participant associated with the client device executing the session monitor client 105 is not active, the media quality analyzer 240 retains the transmitted media loopback scores for inclusion in a loopback status message.

In some examples, the media quality analyzer 240 implements a quality check, or quality confirmation, procedure to check/confirm the accuracy of the received media loopback score(s) and/or the transmitted media loopback score(s) for a given (e.g., current) time interval. The media quality analyzer 240 of the illustrated example implements an example quality check/confirmation procedure based on keyword matching. At a high-level, the media quality analyzer 240 compares keywords detected in speech data and/or chat data to a reference keyword data associated of media quality to determine whether the computed received media loopback score(s) and/or the transmitted media loopback score(s) accurately represent the quality of the received media and/or transmitted media from the participant's perspective. For example, the reference keyword data can include a dictionary of words and phrases that indicate media quality is poor. Example of such keywords and phrases include, but are not limited to:
“I can't hear you.”
“Are you able to hear me?”
“I am not able to hear you?”
“Can you see me?”
“I can't see you?”
“We can't see your screen?”
“Can you see my screen?”

Detection of such keywords and phrases in speech data and/or chat data for a given (e.g., current) time interval can, for example, confirm received media loopback score(s) and/or the transmitted media loopback score(s) associated with poor quality are accurate, or indicate that received media loopback score(s) and/or the transmitted media loopback score(s) associated with good quality are inaccurate.

For example, the media quality analyzer 240 can utilize the driver interface(s) 225 to access local chat data and/or local audio data generated by a local participant during a given (e.g., current) time interval of the online collaboration session. In the case of local audio data, the media quality analyzer 240 can perform speech detection on the audio data to detect speech spoken by the local participant during the given (e.g., current) time interval. The media quality analyzer 240 then compares (e.g., with a trained neural network, machine learning algorithm, artificial intelligence, etc.) the reference keyword data to the local chat data and/or the local speech data to determine a keyword match score indicating whether at least a portion of the local chat data and/or the local speech data matches at least a portion of the reference keyword data. If the keyword match score indicates there is such a match, the media quality analyzer 240 determines that received media quality is poor from the perspective of the local participant and processes the received media loopback scores accordingly. For example, if the received media loopback scores also correspond to values indicating the received media quality is poor, the media quality analyzer 240 retains the received media loopback scores for inclusion in a loopback status message. However, if the received media loopback scores correspond to values indicating the received media quality is good, the media quality analyzer 240 may override those values and set the received media loopback scores to default scores, as described above.

As another example, the media quality analyzer 240 can utilize the application interface 220 to access received chat data and/or received audio data from a remote participant during a given (e.g., current) time interval of the online collaboration session. In the case of received audio data, the media quality analyzer 240 can perform speech detection on the audio data to detect speech spoken by the remote participant during the given (e.g., current) time interval. The media quality analyzer 240 then compares (e.g., with a trained neural network, machine learning algorithm, artificial intelligence, etc.) the reference keyword data to the received chat data and/or the received speech data to determine a keyword match score indicating whether at least a portion of the received chat data and/or the received speech data matches at least a portion of the reference keyword data. If the keyword match score indicates there is such a match, the media quality analyzer 240 determines that transmitted media quality is poor from the perspective of the remote participant and processes the transmitted media loopback scores accordingly. For example, if the transmitted media loopback scores also correspond to values indicating the transmitted media quality is poor, the media quality analyzer 240 retains the transmitted media loopback scores for inclusion in a loopback status message. However, if the transmitted media loopback scores correspond to values indicating the transmitted media quality is good, the media quality analyzer 240 may override those values and set the transmitted media loopback scores to default scores, as described above.

In the illustrated example, the connection status analyzer 245 operates to monitor the status of the online collaboration session itself. For example, the connection status analyzer 245 can utilize the driver interface(s) 225 to connect with the input/output devices (e.g., media endpoints) of the client device and confirm they are active at the start of the online collaboration session. Additionally or alternatively, the connection status analyzer 245 can generate heartbeat and/or keep-alive messages for transmission to the session moderator during the online collaboration session.

In the illustrated example, the status report processor 250 operates to transmit loopback status messages via the feedback channel to a session moderator client. As described above, a session monitor client, such as the session monitor client 105, may act as a session moderator client when the local participant associated with that client is the session organizer and/or the active presenter, etc. As such, in some examples, the status report processor 250 utilizes the application data interface 220 to obtain participant activity status for a given (e.g., current) time interval from the online collaboration application implementing the online collaboration session, as described above. In such examples, the status report processor 250 utilizes the participant activity status to identify the session organizer and/or the active presenter for a given (e.g., current) time interval of the online collaboration session. The status report processor 250 then identifies the session moderator client corresponding to the session organizer and/or the active presenter for the given (e.g., current) time interval.

The status report processor 250 of the illustrated example transmits one or more loopback status messages to the identified session moderator client. For example, the status report processor 250 may generate a loopback status message for the given (e.g., current) time interval that includes the received media loopback scores and/or the transmitted media loopback scores determined by the media quality analyzer 240 for the given (e.g., current) time interval. In some examples, the status report processor 250 also includes an identifier of the given (e.g., current) time interval in the loopback status message. In some examples, the status report processor 250 also includes connection status information, heartbeat messages and/or keep-alive messages from the connection status analyzer 245 in loopback status message. In some examples, the status report processor 250 includes at least a portion of the received media for the given (e.g., current) time interval and/or at least a portion of the transmitted media for the given (e.g., current) time interval in the loopback status message.

As noted above, the session moderator processor 210 is included in the example session monitor client 105 of FIG. 2 to perform session moderator processing when appropriate. As described above, the session monitor client 105 may act as a session moderator client when the local participant associated with the session monitor client 105 is the session organizer and/or the active presenter, etc. As such, in some examples, the session moderator processor 210 utilizes the application data interface 220 to obtain participant activity status for a given (e.g., current) time interval from the online collaboration application implementing the online collaboration session, as described above. In such examples, the session moderator processor 210 evaluates the participant activity status to identify the session organizer and/or the active presenter for a given (e.g., current) time interval of the online collaboration session. If the session organizer and/or the active presenter for the given (e.g., current) time interval is the local participant associated with the session monitor client 105, the session moderator processor 210 remains active for given (e.g., current) time interval. Otherwise, the session moderator processor 210 may deactivate/sleep until the next time interval.

In the illustrated example, assuming the session moderator processor 210 remains active and the session monitor client 105 is to act as the session moderator client at least for the given (e.g., current) time interval, the session moderator processor 210 accesses the loopback status message(s) reported by other, remote session monitor clients and identifies those loopback status message(s) corresponding to the given (e.g., current) time interval. The session moderator processor 210 also evaluates the participant activity status to identify the active participant(s) for the given (e.g., current) time interval. The session moderator processor 210 then determines and outputs a quality status indicator for the given (e.g., current) time interval of the online collaboration session. The session moderator processor 210 of the illustrated example determines the quality status indicator based on the active participant(s) and the loopback status message(s) for the given (e.g., current) time interval.

In some examples, the session moderator processor 210 combines the media loopback scores from the loopback status messages received from multiple remote session monitor clients for the given (e.g., current) time interval to determine a combined media score to be used to determine the quality status indicator for the given (e.g., current) time interval. For example, the session moderator processor 210 can combine (e.g., via a majority vote, an outlier selection, averaging, etc.) the received media loopback scores from the loopback status messages for the given (e.g., current) time interval to determine a combined received media score for the given (e.g., current) time interval of the online collaboration session. Additionally or alternatively, the session moderator processor 210 can combine (e.g., via a majority vote, an outlier selection, averaging, etc.) the transmitted media loopback scores from the loopback status messages for the given (e.g., current) time interval to determine a combined transmitted media score for the given (e.g., current) time interval of the online collaboration session. In some such examples, the session moderator processor 210 determines the quality status indicator based on the active participant(s) and the combined received media loopback score and/or the combined transmitted media loopback score. In some examples, the session moderator processor 210 can determine respective quality status indicators for different participants and/or client devices included in the online collaboration session, such as when the loopback status messages included loopback scores with participant and/or client device identification information that identifies which scores are associated with which participants and/or client devices.

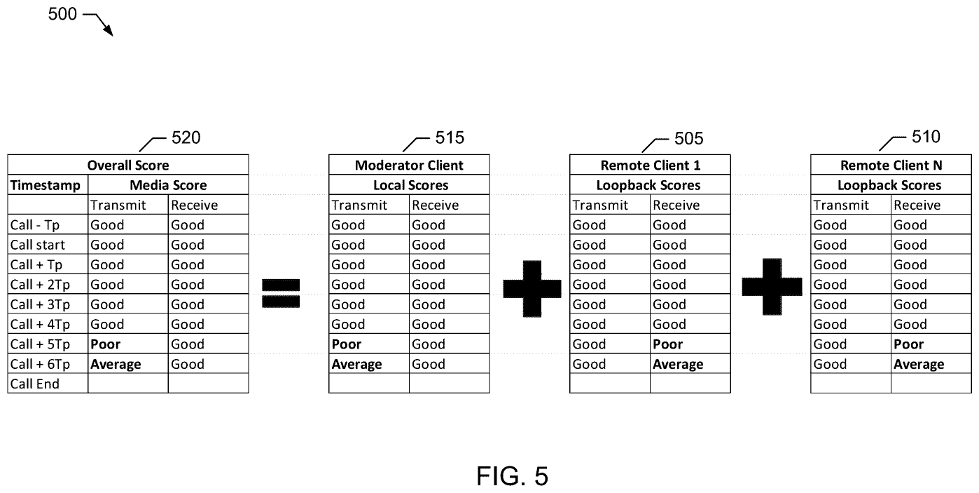

In some examples, the session moderator processor 210 also accesses the local media quality scores determined by the session loopback processor 205 for the given (e.g., current) time interval, as described above, and combines (e.g., via a majority vote, an outlier selection, averaging, etc.) the local media quality scores with the media loopback scores from the loopback status messages for the given (e.g., current) time interval to determine a combined media score for the given (e.g., current) time interval of the online collaboration session. For example, if the local participant associated with the session monitor client 105 is also an active participant for the given (e.g., current) time interval, the session moderator processor 210 can combine (e.g., via a majority vote, an outlier selection, averaging, etc.) the received media loopback scores from the loopback status messages for the given (e.g., current) time interval with a local transmitted media quality score for the given (e.g., current) time interval to determine a combined transmitted media score for the given (e.g., current) time interval of the online collaboration session (from the perspective of the session moderator being an active participant). Additionally or alternatively, the session moderator processor 210 can combine (e.g., via a majority vote, an outlier selection, averaging, etc.) the transmitted media loopback scores from the loopback status messages for the given (e.g., current) time interval with a local transmitted media quality score for the given (e.g., current) time interval to determine a combined received media score for the given (e.g., current) time interval of the online collaboration session (from the perspective of the session moderator being an active participant). An example operation of the session moderator processor 210 to combine media loopback scores is illustrated in FIG. 5, which is described in further detail below.

In some examples, the session moderator processor 210 outputs the combined media loopback scores as the quality status indicator(s) for the given (e.g., current) time interval of the online collaboration session. In some examples, the session moderator processor 210 causes a graphical icon based on the quality status indicator(s) to be displayed in a portion of a video presentation associated with the online collaboration session. For example, the portion of the video presentation can be the portion (e.g., window, frame, etc.) associated with (e.g., depicting) the active participant for the given (e.g., current) time interval of the online collaboration session, the portion (e.g., window, frame, etc.) associated with (e.g., depicting) the participant identified by the participant and/or client device identification information associated with a given quality status indicator, etc. FIG. 6 illustrates such an example video presentation 600. In the illustrated example of FIG. 6, the quality status indicator determined by the session moderator processor 210 based on the combined media loopback score indicates poor media quality for the given (e.g., current) time interval. Based on that quality status indicator, the session moderator processor 210 causes an example graphical icon 605 (e.g., an “X”) to be presented in an example portion 610 of the video presentation 600 that depicts the active participant for the given (e.g., current) time interval.

In some examples, the session moderator processor 210 causes notification(s) to be sent to one or more session participants based on the determined quality status indicator(s). For example, the session moderator processor 210 can cause a notification to be sent to an active session participant for a given (e.g., current) time interval when the quality status indicator indicates the media quality for the given (e.g., current) time interval is poor. For example, the session moderator processor 210 can cause the client device executing the session monitor client 105 to send a chat notification identifying the poor media quality to the active session participant within the online collaboration session. Additionally or alternatively, the session moderator processor 210 can cause the client device executing the session monitor client 105 to send an email message, a text message, etc., to identifying the poor media quality to the active session participant.

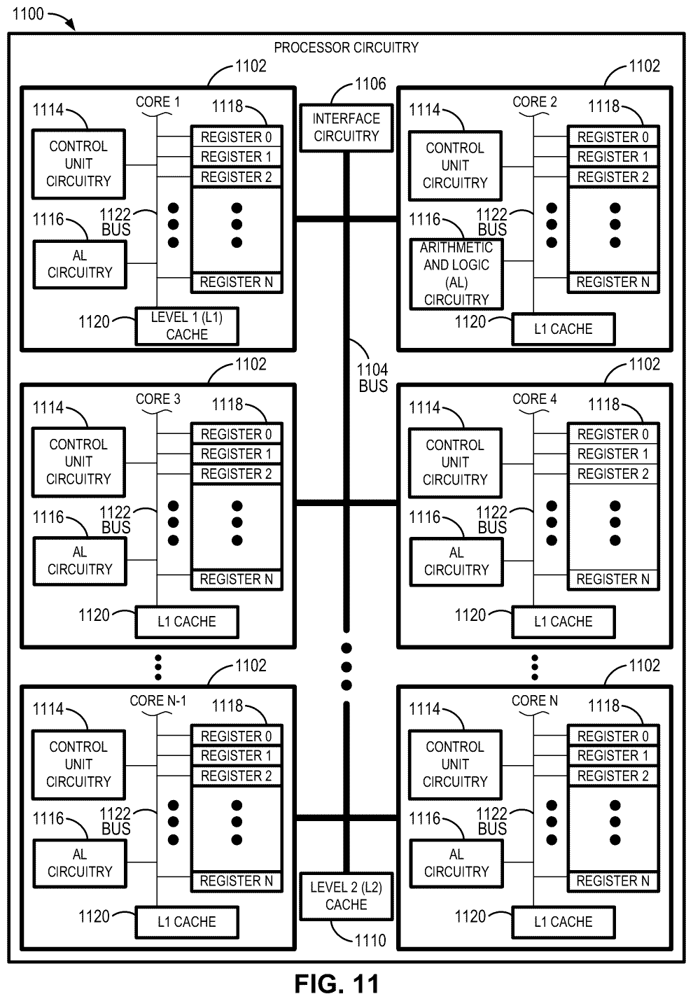

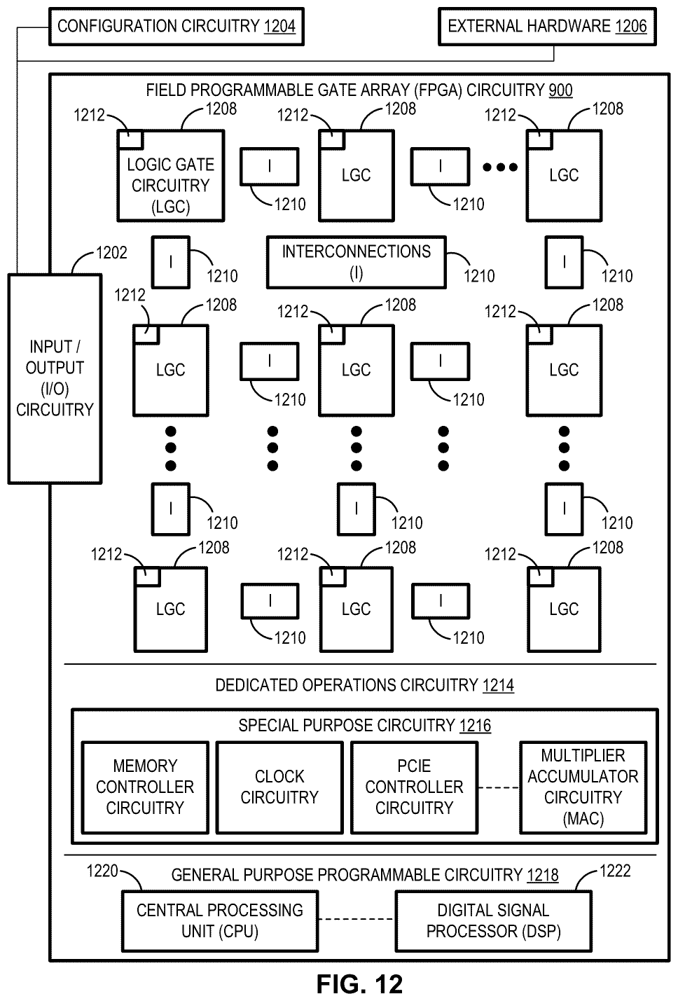

In some examples, the session monitor client 105 includes means for performing session loopback processing for an online collaboration session. For example, the means for performing session loopback processing for an online collaboration session may be implemented by the session loopback processor circuitry 205. In some examples, the session loopback processor circuitry 205 may be instantiated by programmable circuitry such as the example programmable circuitry 1012 of FIG. 10. For instance, the session loopback processor circuitry 205 may be instantiated by the example microprocessor 1100 of FIG. 11 executing machine executable instructions such as those implemented by at least block 710 of FIG. 7. In some examples, the session loopback processor circuitry 205 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the session loopback processor circuitry 205 may be instantiated by any other combination of hardware, software, and/or firmware. For example, the session loopback processor circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

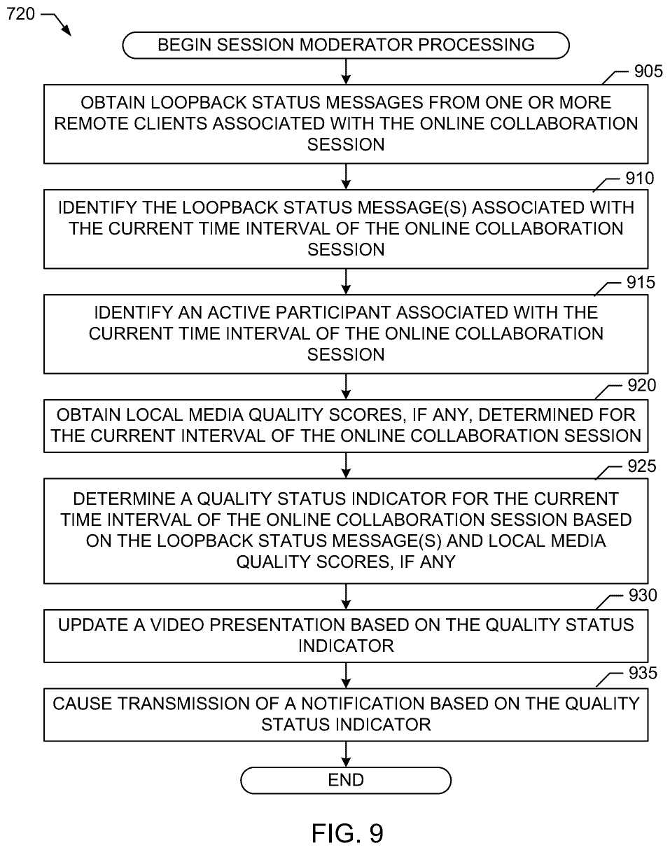

In some examples, the session monitor client 105 includes means for performing session moderator processing for the online collaboration session. For example, the means for session moderator processing for the online collaboration session may be implemented by the session moderator processor circuitry 210. In some examples, the session moderator processor circuitry 210 may be instantiated by programmable circuitry such as the example programmable circuitry 1012 of FIG. 10. For instance, the session moderator processor circuitry 210 may be instantiated by the example microprocessor 1100 of FIG. 11 executing machine executable instructions such as those implemented by at least block 720 of FIG. 7 and/or blocks 905-935 of FIG. 9. In some examples, the session moderator processor circuitry 210 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the session moderator processor circuitry 210 may be instantiated by any other combination of hardware, software, and/or firmware. For example, the session moderator processor circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for implementing a feedback channel. For example, the means for implementing a feedback channel may be implemented by the feedback channel interface circuitry 215. In some examples, the feedback channel interface circuitry 215 may be instantiated by programmable circuitry such as the example programmable circuitry 1012 of FIG. 10. For instance, the feedback channel interface circuitry 215 may be instantiated by the example microprocessor 1100 of FIG. 11 executing machine executable instructions such as those implemented by at least block 705 of FIG. 7. In some examples, the feedback channel interface circuitry 215 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the feedback channel interface circuitry 215 may be instantiated by any other combination of hardware, software, and/or firmware. For example, the feedback channel interface circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for accessing media data associated with an online collaboration application. For example, the means for accessing media data associated with an online collaboration application may be implemented by the application data interface circuitry 220. In some examples, the application data interface circuitry 220 may be instantiated by programmable circuitry such as the example programmable circuitry 1012 of FIG. 10. For instance, the application data interface circuitry 220 may be instantiated by the example microprocessor 1100 of FIG. 11 executing machine executable instructions such as those implemented by at least blocks 805, 815, 825 and/or 830 of FIG. 8. In some examples, the application data interface circuitry 220 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the application data interface circuitry 220 may be instantiated by any other combination of hardware, software, and/or firmware. For example, the application data interface circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for accessing one or more drivers of a client device. For example, the means for accessing one or more drivers of a client device may be implemented by the driver interface(s) 225. In some examples, the driver interface circuitry 225 may be instantiated by programmable circuitry such as the example programmable circuitry 1012 of FIG. 10. For instance, the driver interface circuitry 225 may be instantiated by the example microprocessor 1100 of FIG. 11 executing machine executable instructions such as those implemented by at least blocks 805, 815, 825 and/or 830 of FIG. 8. In some examples, the driver interface circuitry 225 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the driver interface circuitry 225 may be instantiated by any other combination of hardware, software, and/or firmware. For example, the driver interface circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for determining loopback data based on received network data. For example, the means for determining loopback data based on received network data may be implemented by the media packet analyzer circuitry 230. In some examples, the media packet analyzer circuitry 230 may be instantiated by programmable circuitry such as the example programmable circuitry 1012 of FIG. 10. For instance, the media packet analyzer circuitry 230 may be instantiated by the example microprocessor 1100 of FIG. 11 executing machine executable instructions such as those implemented by at least block 810 of FIG. 8. In some examples, the media packet analyzer circuitry 230 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the media packet analyzer circuitry 230 may be instantiated by any other combination of hardware, software, and/or firmware. For example, the media packet analyzer circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for determining loopback data based on local data generated at the client device. For example, the means for determining loopback data based on local data generated at the client device may be implemented by the device analyzer circuitry 235. In some examples, the device analyzer circuitry 235 may be instantiated by programmable circuitry such as the example programmable circuitry 1012 of FIG. 10. For instance, the device analyzer circuitry 235 may be instantiated by the example microprocessor 1100 of FIG. 11 executing machine executable instructions such as those implemented by at least blocks 815 and/or 830 of FIG. 8. In some examples, the device analyzer 235 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the device analyzer circuitry 235 may be instantiated by any other combination of hardware, software, and/or firmware. For example, the device analyzer circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for determining loopback scores. For example, the means for determining loopback scores may be implemented by the media quality analyzer circuitry 240. In some examples, the media quality analyzer circuitry 240 may be instantiated by programmable circuitry such as the example programmable circuitry 1012 of FIG. 10. For instance, the media quality analyzer circuitry 240 may be instantiated by the example microprocessor 1100 of FIG. 11 executing machine executable instructions such as those implemented by at least block 835 of FIG. 8. In some examples, the media quality analyzer circuitry 240 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the media quality analyzer circuitry 240 may be instantiated by any other combination of hardware, software, and/or firmware. For example, the media quality analyzer circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for monitoring status of the online collaboration session. For example, the means for monitoring status of the online collaboration session may be implemented by the connection status analyzer circuitry 245. In some examples, the connection status analyzer circuitry 245 may be instantiated by programmable circuitry such as the example programmable circuitry 1012 of FIG. 10. For instance, the connection status analyzer circuitry 245 may be instantiated by the example microprocessor 1100 of FIG. 11 executing machine executable instructions such as those implemented by at least block 840 of FIG. 8. In some examples, the connection status analyzer circuitry 245 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the connection status analyzer circuitry 245 may be instantiated by any other combination of hardware, software, and/or firmware. For example, the connection status analyzer circuitry 245 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the session monitor client 105 includes means for reporting loopback status messages. For example, the means for reporting loopback status messages may be implemented by the status report processor circuitry 250. In some examples, the status report processor circuitry 250 may be instantiated by programmable circuitry such as the example programmable circuitry 1012 of FIG. 10. For instance, the status report processor circuitry 250 may be instantiated by the example microprocessor 1100 of FIG. 11 executing machine executable instructions such as those implemented by at least block 840 of FIG. 8. In some examples, the status report processor circuitry 250 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the status report processor circuitry 250 may be instantiated by any other combination of hardware, software, and/or firmware. For example, the status report processor circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

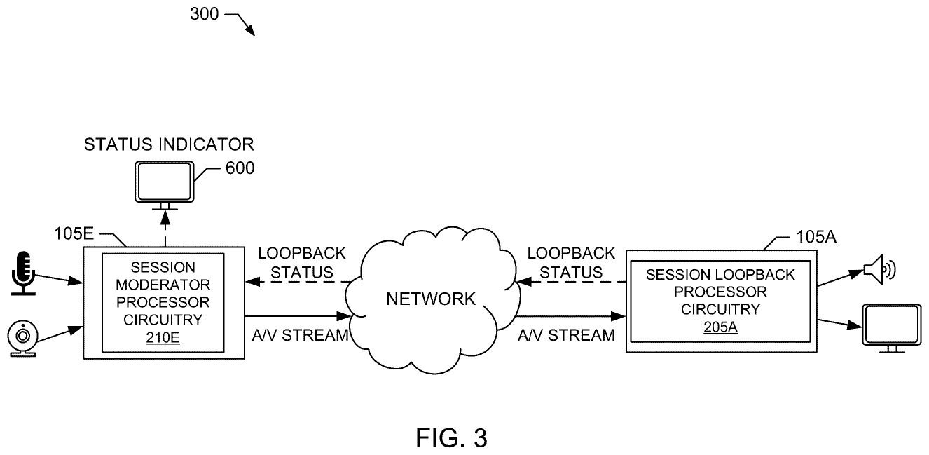

FIG. 3 illustrates another example environment 300 in which the session monitor clients 105A and 105E of FIG. 1 operate to determine example quality scores for an online collaboration session. In the example environment 300, the session monitor clients 105A and 105E are implemented by respective instances of the session monitor client 200 of FIG. 2 described above. As such, the example session monitor client 105A of FIG. 3 includes an example session loopback processor 205A, which corresponds to the session loopback processor 205 of FIG. 2 described above. The example session monitor client 105E of FIG. 3 includes an example session moderator processor 210E, which corresponds to the session moderator processor 210 of FIG. 2 described above.

In the illustrated example of FIG. 3, the session loopback processor 205A of the session monitor client 105A monitors the media data received and to be transmitted by the client device executing the session monitor client 105A to determine received loopback quality scores and transmitted loopback quality scores for successive time intervals of an online collaboration session. An example of the received loopback quality scores and transmitted loopback quality scores determined by the session loopback processor 205A of the session monitor client 105A for an example online collaboration session is illustrated in the table 400 of FIG. 4. The table 400 of FIG. 4 includes rows 405 of example received loopback quality scores and example transmitted loopback quality scores determined by the session loopback processor 205A for successive time intervals of the example online collaboration session.

In the illustrated example of FIG. 4, the duration of a time interval is represented by the variable “Tp” and, thus, the successive time intervals begin with the start of the online collaboration session, represented as “Call start” or more succinctly as “Call,” and occur at multiples of variable “Tp” (e.g., “Call+Tp,” “Call+2TP,” “Call+3TP,” etc.). In the illustrated example of FIG. 4, the transmitted loopback quality scores and the received loopback quality scores determined by the session loopback processor 205A for the successive time intervals the session loopback processor 205A include example transmitted audio quality scores 410, example received audio quality scores 415, example transmitted video quality scores 420, example received video quality scores 425, example transmitted presentation (e.g., screen sharing) data quality scores 430, example received presentation (e.g., screen sharing) data quality scores 435, example transmitted text data quality scores 440, and example received text data quality scores 445. In the illustrated example, the transmitted loopback quality scores and the received loopback quality scores indicate good overall media quality for the monitored time intervals of the online collaboration session except for poor transmitted audio and video quality during the time interval “Call+5Tp,” and average transmitted audio and video quality during the time interval “Call+6Tp.” Thus, the example of FIG. 4 indicates a potential problem with the local audio and video data being transmitted during time intervals “Call+5Tp” and “Call+6Tp” by the client device executing the session monitor client 105A.

In the illustrated example of FIG. 3, the session moderator processor 210E of the session monitor client 105E combines media loopback quality scores reported by remote session monitor clients for an online collaboration session with local media quality scores determined by the session monitor client 105E (acting as a moderator client) to determine combined media quality scores and quality status indicators for successive time intervals of the online collaboration session. An example operation 500 of the session moderator processor 210E to determine combined media quality scores and quality status indicators for an example online collaboration session is illustrated in FIG. 5. In the illustrated example of FIG. 5, the session moderator processor 210E receives example media loopback quality scores 505 for successive time intervals in loopback status messages reported from a first session monitor client. In the illustrated example, the session moderator processor 210E receives example media loopback quality scores 510 for the successive time intervals in loopback status messages reported from a second session monitor client. In the illustrated example, the session monitor client 105E (acting as a moderator client) also determines example local media quality scores 515 for the successive time intervals of the online collaboration session.

In the illustrated example of FIG. 5, the session moderator processor 210E of the session monitor client 105E (acting as a moderator client) combines the media loopback quality scores 505, the media loopback quality scores 510 and the local media quality scores 515 to determine example combined media quality scores 520. In the illustrated example, the local session participant associated with the session monitor client 105E (acting as a moderator client) is actively transmitting media during the monitored time intervals. Thus, the session moderator processor 210E combines the received scores in the media loopback quality scores 505 and 510 with the transmitted scores in the local media quality scores 515 to determine the transmitted scores in the combined media quality scores 520. Likewise, the session moderator processor 210E combines the transmitted scores in the media loopback quality scores 505 and 510 with the received scores in the local media quality scores 515 to determine the received scores in the combined media quality scores 520. In the illustrated example, the combined media quality scores 520 indicate good overall media quality for the monitored time intervals of the online collaboration session except for poor transmitted audio and video quality during the time interval “Call+5Tp,” and average transmitted audio and video quality during the time interval “Call+6Tp.” Thus, the example of FIG. 5 indicates a potential problem with the local audio and video data being transmitted during time intervals “Call+5Tp” and “Call+6Tp” by the client device executing the session monitor client 105E (acting as a moderator client).

While an example manner of implementing the session monitor client 105 is illustrated in FIG. 2, one or more of the elements, processes, and/or devices illustrated in FIG. 2 may be combined, divided, re-arranged, omitted, eliminated, and/or implemented in any other way. Further, the example session loopback processor circuitry 205, the example session moderator processor circuitry 210, the example feedback channel interface circuitry 215, the example application data interface circuitry 220, the example driver interface circuitry 225, the example media packet analyzer circuitry 230, the example device analyzer circuitry 235, the example media quality analyzer circuitry 240, the example connection status analyzer circuitry 245, the example status report processor circuitry 250, and/or, more generally, the example session monitor client 105 of FIG. 2, may be implemented by hardware alone or by hardware in combination with software and/or firmware. Thus, for example, any of the example session loopback processor circuitry 205, the example session moderator processor circuitry 210, the example feedback channel interface circuitry 215, the example application data interface circuitry 220, the example driver interface circuitry 225, the example media packet analyzer circuitry 230, the example device analyzer circuitry 235, the example media quality analyzer circuitry 240, the example connection status analyzer circuitry 245, the example status report processor circuitry 250, and/or, more generally, the example session monitor client 105, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example session monitor client 105 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the session monitor client 105 of FIG. 2 and/or representative of example operations which may be performed by programmable circuitry to implement and/or instantiate the session monitor client 105 of FIG. 2, are shown in FIGS. 7-9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-9, many other methods of implementing the example session monitor client 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to implement the example session monitor client 105 of FIG. 2. The example machine-readable instructions and/or the example operations 700 of FIG. 7 begin at block 705, at which the feedback channel interface 215 of the session monitor client 105 establishes one or more feedback channel(s) for an online collaboration session, as described above. At block 710, the session loopback processor 205 of the session monitor client 105 performs session loopback processing for a current time interval of the online collaboration session, as described above. At block 715, the session moderator processor 210 of the session monitor client 105 determines, as described above, whether the session monitor client 105 is associated with the session moderator (e.g., session organizer, an active presenter performing screen sharing, etc.) for the current time interval of the online collaboration session. If the session monitor client 105 is associated with the session moderator for the current time interval, at block 720 the session moderator processor 210 performs session moderator processing for the current time interval of the online collaboration session, as described above. At block 725, the session monitor client 105 determines whether the online collaboration session is still active. If the online collaboration session is still active, control returns to block 710 to being processing for the next time interval of the online collaboration session. Otherwise, the example machine-readable instructions and/or the example operations 700 of FIG. 7 end.

FIG. 8 is a flowchart representative of example machine readable instructions and/or example operations 710 that may be executed, instantiated, and/or performed by programmable circuitry to implement the example session loopback processor 205 of the example session monitor client 105 of FIG. 2, and/or the session loopback processing at block 710 of FIG. 7. The example machine-readable instructions and/or the example operations 710 of FIG. 8 begin at block 805, at which the media quality analyzer 240 of the session loopback processor 205 detects participant activity status for the current time interval of the online collaboration session, as described above. At block 810, the media packet analyzer 230 of the session loopback processor 205 analyzes received network data associated with the current time interval of the online collaboration session to determine first loopback data including one or more received media quality scores, as described above. At block 815, the media quality analyzer 240 analyzes local data (e.g., local speech and/or chat data) obtained by the local session monitor client 105 during the current time interval of the online collaboration session to determine second loopback data including one or more keyword match scores to be used for received quality checking/confirmation, as described above. At block 820, the media quality analyzer 240 determines, as described above, one or more received media loopback scores for the current interval of the online collaboration session based on the first loopback data determined at block 810, the second loopback data determined at block 815, and the participant activity status determined at block 805.

At block 825, the device analyzer 235 of the session loopback processor 205 determines, as described above, whether the local session participant associated with the session monitor client 105 is actively sending media data in the current time interval of the online collaboration session. If the local session participant is active, at block 830 the device analyzer 235 analyzes local data (e.g., local audio data, local video data, etc.) obtained by the local session monitor client 105 during the current time interval of the online collaboration session to determine one or more transmitted media quality scores to include in third loopback data. At block 835, the media quality analyzer 240 determines, as described above, one or more transmitted media loopback scores for the current interval of the online collaboration session based on the third loopback data determined at block 830 and the second loopback data determined at block 815. At block 840, the status report processor 250 causes transmission of one or more loopback status messages including the received media quality scores and/or the transmitted media quality scores to a moderator client, as described above. The example machine-readable instructions and/or the example operations 710 of FIG. 8 then end.

FIG. 9 is a flowchart representative of example machine readable instructions and/or example operations 720 that may be executed, instantiated, and/or performed by programmable circuitry to implement the example session moderator processor 210 of the example session monitor client 105 of FIG. 2, and/or the session moderator processing at block 720 of FIG. 7. The example machine-readable instructions and/or the example operations 720 of FIG. 9 begin at block 905, at which the session moderator processor 210 obtains loopback status messages from one or more remote session monitor clients associated with the online collaboration session, as described above. At block 910, the session moderator processor 210 identifies the loopback status message(s) associated with the current time interval of the online collaboration session, as described above. At block 915, the session moderator processor 210 identifies an active participant associated with the current time interval of the online collaboration session, as described above. At block 920, the session moderator processor 210 obtains local media quality scores, if any, determined by the session loopback processor 205 (e.g., via the processing at block 710 of FIG. 7) for the current time interval of the online collaboration session, as described above. At block 925, the session moderator processor 210 determines, as described above, one or more quality status indicators based on the loopback status message(s) obtained at block 910 and the local media quality score(s), if any, determined at block 920. At block 925, the session moderator processor 210 causes a video presentation to be updated based on the quality status indicator(s) (e.g., to identify a session participant associated with potential media problems), as described above. At block 930, the session moderator processor 210 causes transmission of one or more notifications based on the quality status indicator(s), as described above. The example machine-readable instructions and/or the example operations 720 of FIG. 9 then end.

FIG. 10 is a block diagram of an example programmable circuitry platform 1000 structured to execute and/or instantiate the example machine-readable instructions and/or the example operations of FIGS. 7-9 to implement the session monitor client 105 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example session loopback processor circuitry 205, the example session moderator processor circuitry 210, the example feedback channel interface circuitry 215, the example application data interface circuitry 220, the example driver interface circuitry 225, the example media packet analyzer circuitry 230, the example device analyzer circuitry 235, the example media quality analyzer circuitry 240, the example connection status analyzer circuitry 245, the example status report processor circuitry 250, and/or, more generally, the example session monitor client 105 of FIG. 2.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 7-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7-9 to effectively instantiate the circuitry of FIG. 2 as logic circuits to perform operations corresponding to those machine readable instructions. In some such examples, the circuitry of FIG. 2 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-9. As such, the FPGA circuitry 1200 may be configured and/or structured to effectively instantiate some or all of the operations/functions corresponding to the machine readable instructions of the flowchart(s) of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIG. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIG. 2 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 2 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

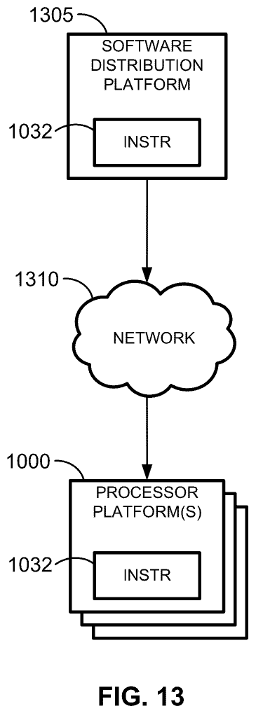

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIG. 7-9, may be downloaded to the example programmable circuitry platform 1000, which is to execute the machine readable instructions 1032 to implement the session monitor client 105. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement quality status loopback for online collaboration sessions. Disclosed systems, apparatus, articles of manufacture, and methods improve the efficiency of using a computing device by implementing a loopback mechanism to monitor media quality locally at the individual client devices of the online collaboration system and report status to a session moderator, which uses the reported status to display problems occurring during the current interval of the online session and/or notify a particular participant associated with a detected problem. Disclosed systems, apparatus, articles of manufacture, and methods are accordingly directed to one or more improvement(s) in the operation of a machine such as a computer or other electronic device included in an online collaboration session.

Further examples and combinations thereof include the following. Example 1 includes an apparatus to provide loopback status for an online collaboration session, the apparatus comprising interface circuitry to receive network data communicated via a first channel associated with the online collaboration session, the network data including received media data packets. The apparatus of example 1 also includes machine readable instructions, and programmable circuitry to operate based on the machine readable instructions to establish a second channel between a local client and a moderator client, the second channel different from the first channel, analyze the network data to determine first loopback data associated with the online collaboration session, the first loopback data including at least one of a first quality score based on a first analysis of the received media data packets or a second quality score based on a second analysis of media decoded from the received media data packets, analyze local data obtained by the local client during the online collaboration session to determine second loopback data associated with the online collaboration session, and cause transmission of a loopback message to the moderator client via the second channel, the loopback message based on the first loopback data and the second loopback data.

Example 2 includes the apparatus of example 1, wherein the first analysis is to determine at least one of a packet loss metric, a round trip time metric, a retransmission metric or an error rate metric associated with the received media data packets, and the second analysis is to determine at least one of a frame rate or a signal-to-noise ratio associated with the media decoded from the received media data packets.

Example 3 includes the apparatus of example 2, wherein the local data includes at least one of local chat data or local audio data to be transmitted during the online collaboration session, and the programmable circuitry is to analyze the local data by comparing reference keyword data to at least one of the local chat data or speech data detected from the local audio data to determine a keyword match score.

Example 4 includes the apparatus of example 3, wherein the network data and the local data correspond to a first time interval of the online collaboration sessions, and the programmable circuitry is to determine a received media loopback score for the first time interval based on the keyword match score, at least one of the first quality score or the second quality score, and a participant activity status, and include the received media loopback score and an identifier of the first time interval in the loopback message.

Example 5 includes the apparatus of example 4, wherein the programmable circuitry is to set the received media loopback score based on at least one of the first quality score or the second quality score when the keyword match score indicates the at least one of the local chat data or the speech data does not match the reference keyword data, and the participant activity status indicates presence of an active participant during the first time interval of the online collaboration session, and set the received media loopback score to a default score when at least one of (i) the keyword match score indicates at least a portion of the at least one of the local chat data or the local audio data of the speech data matches at least a portion of the reference keyword data, or (ii) the participant activity status indicates no active participant during the first time interval of the online collaboration session.

Example 6 includes the apparatus of example 1, wherein the network data includes first media data associated with a remote participant of the online collaboration session, the local data includes second media data associated with a local participant of the online collaboration session, the first media data and the second media data correspond to a first time interval of the online collaboration session, the first loopback data includes a received media quality score, the second loopback data includes a transmitted media quality score, and the programmable circuitry is to determine a received media loopback score for the first time interval based on the first loopback data, determine a transmitted media loopback score for the first time interval based on the second loopback data, and include the received media loopback score, the transmitted media loopback score and an identifier of the first time interval in the loopback message.

Example 7 includes the apparatus of example 6, wherein the programmable circuitry is to include at least a portion of the first media data in the loopback message.

Example 8 includes the apparatus of example 6, wherein the received media loopback score includes a received audio loopback score, a received video loopback score, and a received screen sharing score for the first media data associated with the remote participant of the online collaboration session, and the transmitted media loopback score includes a transmitted audio loopback score, a transmitted video loopback score and a transmitted screen sharing score for the second media data associated with the local participant of the online collaboration session.

Example 9 includes an apparatus to provide loopback status for an online collaboration session, the apparatus comprising interface circuitry to receive loopback messages associated with the online collaboration session, machine readable instructions, and programmable circuitry to operate based on the machine readable instructions to identify a first plurality of the loopback messages associated with a first time interval of the online collaboration session, the first plurality of the loopback messages from a respective plurality of remote clients associated with the online collaboration session, identify an active participant associated with the first time interval of the online collaboration session, and output a quality status indicator for the first time interval of the online collaboration session, the quality status indicator based on the active participant and a combination of loopback scores from the first plurality of the loopback messages.

Example 10 includes the apparatus of example 9, wherein the loopback scores from the first plurality of the loopback messages include received media loopback scores and transmitted media loopback scores, and the programmable circuitry is to combine the received media loopback scores from the first plurality of the loopback messages to determine a combined received media score for the first time interval of the online collaboration session, combine the transmitted media loopback scores from the first plurality of the loopback messages to determine a combined transmitted media score for the first time interval of the online collaboration session, and include the combined received media score and the combined transmitted media score in the quality status indicator.

Example 11 includes the apparatus of example 9, wherein the programmable circuitry is to analyze data associated with the online collaboration session to determine a local quality score for the first time interval of the online collaboration session, and combine the local quality score and the loopback scores from the first plurality of the loopback messages to determine the quality status indicator.

Example 12 includes the apparatus of example 9, wherein the programmable circuitry is to cause a graphical icon to be displayed in a portion of a video presentation associated with the online collaboration session, the portion of the video presentation associated with the active participant, the graphical icon based on the quality status indicator.

Example 13 includes the apparatus of example 9, wherein the programmable circuitry is to cause transmission of a notification to the active participant, the notification based on the quality status indicator.

Example 14 includes a non-transitory machine readable storage medium comprising instructions to cause programmable circuitry to at least analyze network data associated with a first time interval of an online collaboration session to determine first loopback data associated with the first time interval of the online collaboration session, analyze local data obtained by a local client during the first time interval of the online collaboration session to determine second loopback data associated with the first time interval of the online collaboration session, cause transmission of a first loopback message to a moderator client associated with the first time interval of the online collaboration session, the first loopback message based on the first loopback data and the second loopback data, access second loopback messages associated with a second time interval of the online collaboration session, and output a quality status indicator for the second time interval of the online collaboration session, the quality status indicator based on the second loopback messages.

Example 15 includes the non-transitory machine readable storage medium of example 14, wherein the network data includes received media data packets, the first loopback data includes at least one of a first quality score or a second quality score, the local data includes at least one of local chat data or local audio data to be transmitted during the first time interval of the online collaboration session, and the instructions are to cause the programmable circuitry to analyze the network data by at least one of (i) performing a first analysis the received media data packets to determine the first quality score, or (ii) performing a second analysis of media decoded from the received media data packets to determine the second quality score, analyze the local data by comparing reference keyword data to at least one of the local chat data or speech data detected from the local audio data to determine a keyword match score, determine a received media loopback score for the first time interval based on the keyword match score, at least one of the first quality score or the second quality score, and a participant activity status, and include the received media loopback score and an identifier of the first time interval in the first loopback message.

Example 16 includes the non-transitory machine readable storage medium of example 14, wherein the network data includes first media data associated with a remote participant of the online collaboration session, the local data includes second media data associated with a local participant of the online collaboration session, the first media data and the second media data correspond to a first time interval of the online collaboration session, the first loopback data includes a received media quality score, the second loopback data includes a transmitted media quality score, and the instructions are to cause the programmable circuitry to determine a received media loopback score for the first time interval based on the first loopback data, determine a transmitted media loopback score for the first time interval based on the second loopback data, and include the received media loopback score, the transmitted media loopback score and an identifier of the first time interval in the first loopback message.

Example 17 includes the non-transitory machine readable storage medium of example 14, wherein the instructions are to cause the programmable circuitry to combine loopback scores from the second loopback messages to determine the quality status indicator.

Example 18 includes the non-transitory machine readable storage medium of example 14, wherein the network data is to be received via a first channel and the instructions are to cause the programmable circuitry to establish a second channel between the local client and the moderator client, the second channel different from the first channel, the first loopback message to be transmitted to the moderator client via the second channel.

Example 19 includes the non-transitory machine readable storage medium of example 14, wherein the network data includes first media data associated with a remote participant of the online collaboration session, and the instructions are to cause the programmable circuitry to include at least a portion of the first media data in the first loopback message.

Example 20 includes the non-transitory machine readable storage medium of example 14, wherein the instructions are to cause the programmable circuitry to cause a graphical icon to be displayed in a portion of a video presentation associated with the online collaboration session, the graphical icon based on the quality status indicator.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to provide loopback status for an online collaboration session, the apparatus comprising:
interface circuitry to receive network data communicated via a first channel associated with the online collaboration session, the network data including received media data packets;
machine readable instructions; and
programmable circuitry to operate based on the machine readable instructions to:
establish a second channel between a local client and a moderator client, the second channel different from the first channel;
analyze the network data to determine first loopback data associated with the online collaboration session, the first loopback data including at least one of a first quality score based on a first analysis of the received media data packets or a second quality score based on a second analysis of media decoded from the received media data packets;
analyze local data obtained by the local client during the online collaboration session to determine second loopback data associated with the online collaboration session; and
cause transmission of a loopback message to the moderator client via the second channel, the loopback message based on the first loopback data and the second loopback data.

2. The apparatus of claim 1, wherein the first analysis is to determine at least one of a packet loss metric, a round trip time metric, a retransmission metric or an error rate metric associated with the received media data packets, and the second analysis is to determine at least one of a frame rate or a signal-to-noise ratio associated with the media decoded from the received media data packets.

3. The apparatus of claim 2, wherein the local data includes at least one of local chat data or local audio data to be transmitted during the online collaboration session, and the programmable circuitry is to analyze the local data by comparing reference keyword data to at least one of the local chat data or speech data detected from the local audio data to determine a keyword match score.

4. The apparatus of claim 3, wherein the network data and the local data correspond to a first time interval of the online collaboration sessions, and the programmable circuitry is to:
determine a received media loopback score for the first time interval based on the keyword match score, at least one of the first quality score or the second quality score, and a participant activity status; and
include the received media loopback score and an identifier of the first time interval in the loopback message.

5. The apparatus of claim 4, wherein the programmable circuitry is to:
set the received media loopback score based on at least one of the first quality score or the second quality score when the keyword match score indicates the at least one of the local chat data or the speech data does not match the reference keyword data, and the participant activity status indicates presence of an active participant during the first time interval of the online collaboration session; and
set the received media loopback score to a default score when at least one of (i) the keyword match score indicates at least a portion of the at least one of the local chat data or the local audio data of the speech data matches at least a portion of the reference keyword data, or (ii) the participant activity status indicates no active participant during the first time interval of the online collaboration session.

6. The apparatus of claim 1, wherein the network data includes first media data associated with a remote participant of the online collaboration session, the local data includes second media data associated with a local participant of the online collaboration session, the first media data and the second media data correspond to a first time interval of the online collaboration session, the first loopback data includes a received media quality score, the second loopback data includes a transmitted media quality score, and the programmable circuitry is to:
determine a received media loopback score for the first time interval based on the first loopback data;
determine a transmitted media loopback score for the first time interval based on the second loopback data; and
include the received media loopback score, the transmitted media loopback score and an identifier of the first time interval in the loopback message.

7. The apparatus of claim 6, wherein the programmable circuitry is to include at least a portion of the first media data in the loopback message.

8. The apparatus of claim 6, wherein the received media loopback score includes a received audio loopback score, a received video loopback score, and a received screen sharing score for the first media data associated with the remote participant of the online collaboration session, and the transmitted media loopback score includes a transmitted audio loopback score, a transmitted video loopback score and a transmitted screen sharing score for the second media data associated with the local participant of the online collaboration session.

9. An apparatus to provide loopback status for an online collaboration session, the apparatus comprising:
interface circuitry to receive loopback messages associated with the online collaboration session;
machine readable instructions; and
programmable circuitry to operate based on the machine readable instructions to:
identify a first plurality of the loopback messages associated with a first time interval of the online collaboration session, the first plurality of the loopback messages from a respective plurality of remote clients associated with the online collaboration session;
identify an active participant associated with the first time interval of the online collaboration session; and
output a quality status indicator for the first time interval of the online collaboration session, the quality status indicator based on the active participant and a combination of loopback scores from the first plurality of the loopback messages.

10. The apparatus of claim 9, wherein the loopback scores from the first plurality of the loopback messages include received media loopback scores and transmitted media loopback scores, and the programmable circuitry is to:
combine the received media loopback scores from the first plurality of the loopback messages to determine a combined received media score for the first time interval of the online collaboration session;
combine the transmitted media loopback scores from the first plurality of the loopback messages to determine a combined transmitted media score for the first time interval of the online collaboration session; and
include the combined received media score and the combined transmitted media score in the quality status indicator.

11. The apparatus of claim 9, wherein the programmable circuitry is to:
analyze data associated with the online collaboration session to determine a local quality score for the first time interval of the online collaboration session; and
combine the local quality score and the loopback scores from the first plurality of the loopback messages to determine the quality status indicator.

12. The apparatus of claim 9, wherein the programmable circuitry is to cause a graphical icon to be displayed in a portion of a video presentation associated with the online collaboration session, the portion of the video presentation associated with the active participant, the graphical icon based on the quality status indicator.

13. The apparatus of claim 9, wherein the programmable circuitry is to cause transmission of a notification to the active participant, the notification based on the quality status indicator.

14. A non-transitory machine readable storage medium comprising instructions to cause programmable circuitry to at least:
analyze network data associated with a first time interval of an online collaboration session to determine first loopback data associated with the first time interval of the online collaboration session;
analyze local data obtained by a local client during the first time interval of the online collaboration session to determine second loopback data associated with the first time interval of the online collaboration session;
cause transmission of a first loopback message to a moderator client associated with the first time interval of the online collaboration session, the first loopback message based on the first loopback data and the second loopback data;
access second loopback messages associated with a second time interval of the online collaboration session; and
output a quality status indicator for the second time interval of the online collaboration session, the quality status indicator based on the second loopback messages.

15. The non-transitory machine readable storage medium of claim 14, wherein the network data includes received media data packets, the first loopback data includes at least one of a first quality score or a second quality score, the local data includes at least one of local chat data or local audio data to be transmitted during the first time interval of the online collaboration session, and the instructions are to cause the programmable circuitry to:
analyze the network data by at least one of (i) performing a first analysis the received media data packets to determine the first quality score, or (ii) performing a second analysis of media decoded from the received media data packets to determine the second quality score;
analyze the local data by comparing reference keyword data to at least one of the local chat data or speech data detected from the local audio data to determine a keyword match score;
determine a received media loopback score for the first time interval based on the keyword match score, at least one of the first quality score or the second quality score, and a participant activity status; and
include the received media loopback score and an identifier of the first time interval in the first loopback message.

16. The non-transitory machine readable storage medium of claim 14, wherein the network data includes first media data associated with a remote participant of the online collaboration session, the local data includes second media data associated with a local participant of the online collaboration session, the first media data and the second media data correspond to a first time interval of the online collaboration session, the first loopback data includes a received media quality score, the second loopback data includes a transmitted media quality score, and the instructions are to cause the programmable circuitry to:
determine a received media loopback score for the first time interval based on the first loopback data;
determine a transmitted media loopback score for the first time interval based on the second loopback data; and
include the received media loopback score, the transmitted media loopback score and an identifier of the first time interval in the first loopback message.

17. The non-transitory machine readable storage medium of claim 14, wherein the instructions are to cause the programmable circuitry to combine loopback scores from the second loopback messages to determine the quality status indicator.

18. The non-transitory machine readable storage medium of claim 14, wherein the network data is to be received via a first channel and the instructions are to cause the programmable circuitry to establish a second channel between the local client and the moderator client, the second channel different from the first channel, the first loopback message to be transmitted to the moderator client via the second channel.

19. The non-transitory machine readable storage medium of claim 14, wherein the network data includes first media data associated with a remote participant of the online collaboration session, and the instructions are to cause the programmable circuitry to include at least a portion of the first media data in the first loopback message.

20. The non-transitory machine readable storage medium of claim 14, wherein the instructions are to cause the programmable circuitry to cause a graphical icon to be displayed in a portion of a video presentation associated with the online collaboration session, the graphical icon based on the quality status indicator.
